(19) United States
(12) Patent Application Publication
(10) Pub. No.: US 2026/0163483 A1
(43) Pub. Date: Jun. 11, 2026

(54) System and Method for Maintaining Constant Switching Frequency in a Constant On-Time Controller

(71) Applicant: Reed Semiconductor Corporation, Warwick, RI (US)

(72) Inventors: Biranchinath Sahu, Bangalore (IN); Umang Bhadreshkumar Shah, Bengaluru (IN)

(21) Appl. No.: 18/972,486

(22) Filed: Dec. 6, 2024

(51) Int. Cl. H02M 3/157; H02M 1/00

(52) U.S. Cl. CPC H02M 3/157; H02M 1/0012

(57) ABSTRACT

An apparatus includes a constant on-timer configured to determine a turn-off instant of a high side switch of a power converter based on a comparison between a ramp signal and a reference, and a frequency correction unit comprising a sampling circuit configured to sample a pulse width modulation (PWM) signal and create a digital representation of the PWM signal, a comparison unit configured to compare the digital representation of the PWM signal with a reference frequency signal to obtain a frequency difference in each PWM cycle of the power converter, wherein the comparison unit is configured to generate a frequency control signal based on an average of N frequency differences obtained in N PWM cycles, and an on-time adjustment unit configured to adjust the refence based on the frequency control signal.

### TECHNICAL FIELD

The present disclosure relates generally to the field of power conversion systems, and in particular embodiments, to a frequency control apparatus in a constant on-time controller.

### BACKGROUND

As technologies further advance, a variety of electronic devices, such as mobile phones, tablet PCs, digital cameras, MP3 players and/or the like, have become popular. Each electronic device requires direct current power at a substantially constant voltage which may be regulated within a specified tolerance even when the current drawn by the electronic device may vary over a wide range. In order to maintain the voltage within the specified tolerance, a power converter (e.g., a switching dc/dc converter) coupled to the electronic device provides very fast transient responses, while keeping a stable output voltage under various load transients.

Hysteretic-based power converter control schemes such as the constant on-time scheme can enable power converters to provide fast transient responses. A step-down non-isolated power converter (e.g., buck converter) employing the constant on-time control scheme may only comprise a feedback comparator and an on-timer. In operation, the feedback circuit of the power converter (e.g., buck converter) directly compares a feedback signal with an internal reference. When the feedback signal falls below the internal reference, the high side switch of the power converter is turned on and remains on for the on-timer duration. As a result of turning on the high side switch, the inductor current of the power converter rises in a linear manner. The high side switch of the power converter turns off when the on-timer expires, and does not turn on until the feedback signal falls below the internal reference again. In summary, when the constant on-time control scheme is employed in a power converter, the on-time of the high side switch of the power converter is terminated by the on-timer. The off-time of the high side switch of the power converter is terminated by the feedback comparator.

In conventional constant on-time control, the switching frequency is inherently variable, as it changes in response to load and input voltage fluctuations. While this variability can improve transient response, it may lead to electromagnetic interference (EMI) challenges and difficulties in designing filters optimized for a specific frequency. This disclosure addresses these limitations by introducing a frequency control apparatus and the associated control method for achieving fixed-frequency constant on-time control. By stabilizing the switching frequency, the disclosure combines the fast transient response benefits of the constant on-time control with the predictability and simplicity of fixed-frequency operation, resulting in improved performance, easier EMI management, and more efficient power conversion across a wide range of operating conditions.

### SUMMARY

Technical advantages are generally achieved, by embodiments of this disclosure which describe a frequency control apparatus in a constant on-time controller.

In accordance with one aspect of the present disclosure, an apparatus comprises a constant on-timer configured to determine a turn-off instant of a high side switch of a power converter based on a comparison between a ramp signal and a reference, and a frequency correction unit comprising a sampling circuit configured to sample a pulse width modulation (PWM) signal and create a digital representation of the PWM signal, a comparison unit configured to compare the digital representation of the PWM signal with a reference frequency signal to obtain a frequency difference in each PWM cycle of the power converter, wherein the comparison unit is configured to generate a frequency control signal based on an average of N frequency differences obtained in N PWM cycles, and an on-time adjustment unit configured to adjust the refence based on the frequency control signal.

In accordance with another aspect of the present disclosure, a method comprises sampling a PWM signal of a power converter and creating a digital representation of the PWM signal, comparing the digital representation of the PWM signal with a reference frequency signal to generate a frequency control signal, wherein the frequency control signal is generated based on comparing the digital representation of the PWM signal with the reference frequency signal in a plurality of PWM cycles of the power converter, generating a threshold voltage using an on-time adjustment unit, wherein the threshold voltage is adjustable based on the frequency control signal applied to the on-time adjustment unit, and generating a ramp, wherein a turn-off instant of a high side switch of the power converter is determined based on a comparison between the ramp signal and the threshold voltage.

In accordance with another aspect of the present disclosure, a power conversion system comprises a power converter connected between an input voltage bus and an output voltage bus, and a controller comprising a constant on-timer configured to determine a turn-off instant of a high side switch of a power converter based on a comparison between a ramp signal and a reference, and a frequency correction unit comprising a sampling circuit configured to sample a pulse width modulation (PWM) signal and create a digital representation of the PWM signal, a comparison unit configured to compare the digital representation of the PWM signal with a reference frequency signal to obtain a frequency difference in each PWM cycle of the power converter, wherein the comparison unit is configured to generate a frequency control signal based on an average of N frequency differences obtained in N PWM cycles, and an on-time adjustment unit configured to adjust the refence based on the frequency control signal.

The foregoing has outlined rather broadly the features and technical advantages of the present disclosure in order that the detailed description of the disclosure that follows may be better understood. Additional features and advantages of the disclosure will be described hereinafter which form the subject of the claims of the disclosure. It should be appreciated by those skilled in the art that the conception and specific embodiment disclosed may be readily utilized as a basis for modifying or designing other structures or processes for carrying out the same purposes of the present disclosure. It should also be realized by those skilled in the art that such equivalent constructions do not depart from the spirit and scope of the disclosure as set forth in the appended claims.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 illustrates a block diagram of a power conversion system in accordance with various embodiments of the present disclosure;

FIG. 2 illustrates a schematic diagram of the smart power stage shown in FIG. 1 in accordance with various embodiments of the present disclosure;

FIG. 3 illustrates a block diagram of a frequency control apparatus in accordance with various embodiments of the present disclosure;

FIG. 4 illustrates a schematic diagram of a constant on timer in accordance with various embodiments of the present disclosure;

FIG. 5 illustrates a schematic diagram of the on-time adjustment unit shown in FIG. 3 in accordance with various embodiments of the present disclosure; and

FIG. 6 illustrates a flow chart of a method for controlling the switching frequency in the power conversion system shown in FIG. 1 in accordance with various embodiments of the present disclosure.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF ILLUSTRATIVE EMBODIMENTS

The making and using of embodiments of this disclosure are discussed in detail below. It should be appreciated, however, that the concepts disclosed herein can be embodied in a wide variety of specific contexts, and that the specific embodiments discussed herein are merely illustrative and do not serve to limit the scope of the claims. Further, it should be understood that various changes, substitutions and alterations can be made herein without departing from the spirit and scope of this disclosure as defined by the appended claims.

Further, one or more features from one or more of the following described embodiments may be combined to create alternative embodiments not explicitly described, and features suitable for such combinations are understood to be within the scope of this disclosure. It is therefore intended that the appended claims encompass any such modifications or embodiments.

The present disclosure will be described with respect to embodiments in a specific context, namely a frequency control apparatus in a step-down power conversion system. The disclosure may also be applied, however, to a variety of power conversions systems. Hereinafter, various embodiments will be explained in detail with reference to the accompanying drawings.

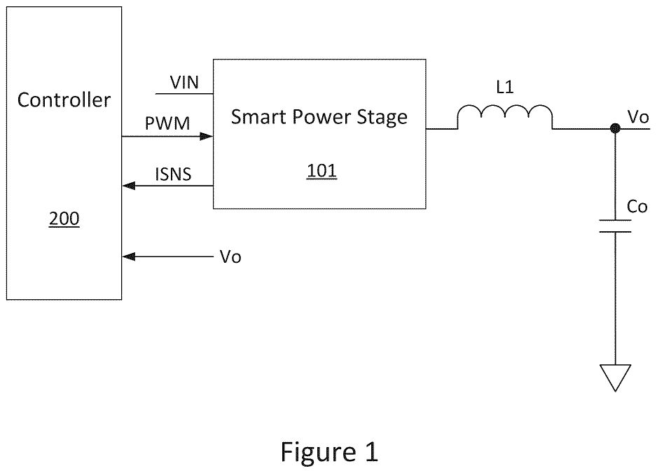

FIG. 1 illustrates a block diagram of a power conversion system in accordance with various embodiments of the present disclosure. The power conversion system comprises a controller 200, a smart power stage 101, an inductor L1, and an output capacitor Co. As shown in FIG. 1, the smart power stage 101 and the inductor L1 are connected in series to form a power conversion stage. In some embodiments, the power conversion stage is a step-down power conversion stage. As shown in FIG. 1, this step-down power conversion stage is connected between an input voltage bus VIN and an output voltage bus Vo. A load (not shown) is coupled to the output voltage bus Vo. In some embodiments, the load may be a processor (e.g., a central processing unit).

The controller 200 is connected to the smart power stage 101. As shown in FIG. 1, the controller 200 receives a current sense signal ISNS sent from the smart power stage 101 and the output voltage Vo. Based on the received signals, the controller 200 is configured to generate a PWM signal fed into the smart power stage 101. The PWM signal is used for controlling the output voltage.

The smart power stage 101 includes current sensing mechanisms to measure the current flowing through it. The sensed current data is then sent back to the controller 200. The current sense signal is used by the controller 200 to adjust the PWM signal dynamically.

In some embodiments, the controller 200 may be a system controller or a system control apparatus. The controller 200 may be implemented as a microprocessor, a digital signal processor and the like.

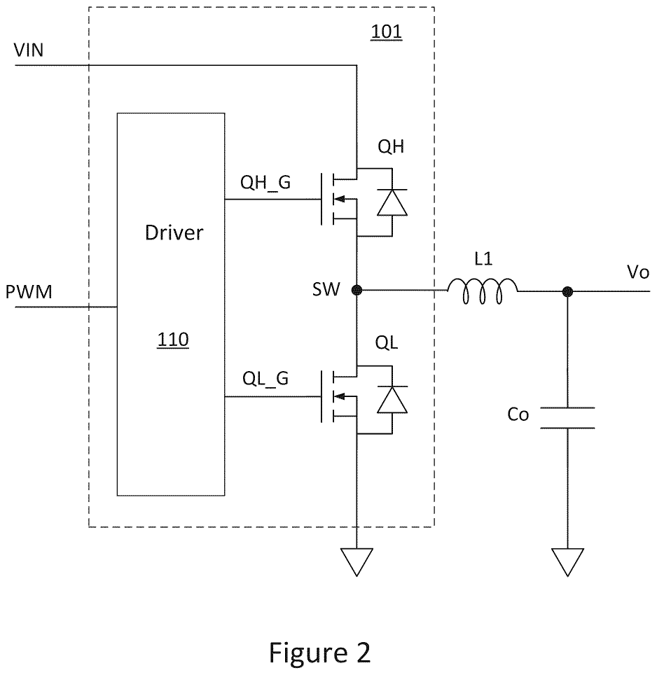

In some embodiments, the power conversion stage formed by the smart power stage 101, the inductor L1 and the output capacitor Co is implemented as a step-down power converter. In some embodiments, the smart power stage 101 comprises both high side and low side power switches responsible for regulating the output voltage of the step-down power converter. The smart power stage 101 also includes the gate driver circuitry that controls the high side and low side power switches, optimizing the switching operation for speed and efficiency. The smart power stage 101 may further comprise other key components such as current sensing, temperature sensing, overcurrent protection, overvoltage protection, under-voltage protection and various digital communication interfaces. The detailed structure of the smart power stage 101 will be described below with respect to FIG. 2.

Alternatively, the power conversion stage may be implemented as any suitable power converters such as an inductor-inductor-capacitor (LLC) converter, a switched capacitor converter, a hybrid switched capacitor converter, a full bridge power converter, a half bridge power converter, a buck converter, any combinations thereof and the like.

In some embodiments, the controller 200 is constant on-time controller. A constant on-time control scheme is employed to control the power conversions system. The control loop of the constant on-time control scheme includes a feedback comparator and an on-timer. In operation, a feedback signal of the output voltage is directly compared with a predetermined reference. When the feedback signal falls below the predetermined reference, the high side switch is turned on and remains on for the on-timer duration. The high side switch turns off when the on-timer expires, and does not turn on until the feedback signal falls below the internal reference again.

In a conventional constant on-time control scheme, the switching frequency of a constant on-time controlled power converter is inherently variable. In order to achieve fixed-frequency constant on-time control, a frequency control apparatus is included in the controller 200.

In operation, the frequency control apparatus is configured to sample the PWM signal and create a digital representation of the PWM signal. The digital representation of the PWM signal includes the time period information of the PWM signal. A reference switching frequency is saved in a lookup table, which provides the corresponding time period information for the reference frequency. In each switching cycle of the power conversion system, the frequency control apparatus compares the time period of the PWM signal with the time period of the reference switching frequency to calculate a frequency difference. Based on the comparison results in N switching cycles, the frequency control apparatus is able to compute an average of N frequency differences, and produce a frequency control signal based on the calculated average. In some embodiments, N is in a range from about 1,000 to about 10,000.

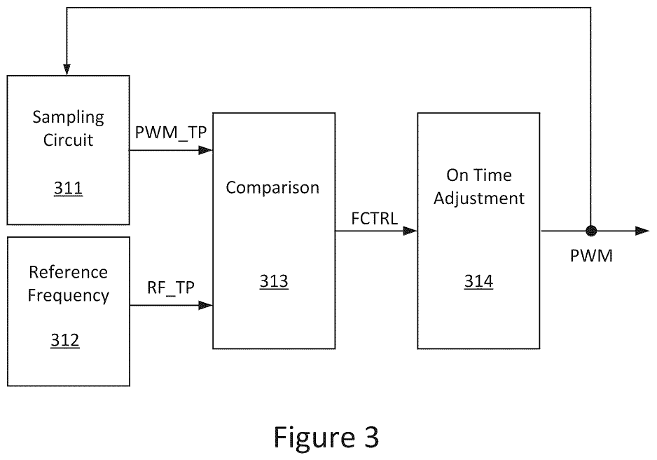

During operation, the frequency control signal adjusts a digital potentiometer to modify a threshold voltage of the on-timer. In the constant on-time control scheme, the switching frequency is inversely related to the on-time of the high side switch. By altering the threshold voltage of the on-timer, the on-time of the high side switch adjusts correspondingly. Specifically, increasing the threshold voltage lengthens the on-time of the high side switch, reducing the switching frequency. Conversely, lowering the threshold voltage shortens the on-time, resulting in an increased switching frequency. As such, the frequency control apparatus is able to adjust the switching frequency of the power conversion system shown in FIG. 1 based on the reference switching frequency. As a result, the power converter operates at a constant switching frequency. The detailed schematic diagram of the frequency control apparatus will be described below with respect to FIGS. 3-5.

FIG. 2 illustrates a schematic diagram of the smart power stage shown in FIG. 1 in accordance with various embodiments of the present disclosure. The smart power stage 101 comprises a high side switch QH, a low side switch QL and a driver 110. As shown in FIG. 2, the high side switch QH and the low side switch QL are connected in series between the input voltage bus VIN and ground. An output inductor L1 is connected between a common node (SW) of the high side switch QH and the low side switch QL, and the output voltage bus Vo. The output capacitor Co is connected between the output voltage bus Vo and ground. The driver 110 is configured to receive a PWM signal (PWM) from the controller 200. Based on the received PWM signal, the driver 110 generates gate drive signals QH_G and QL_G for the high side switch QH and the low side switch QL, respectively. In some embodiments, the high side switch QH, the low side switch QL and the driver 110 are in a smart power stage semiconductor package.

In operation, when the high side switch QH is turned on, and the low side switch QL is turned off, a current flows from the input voltage VIN to the load through the output inductor L1. The output inductor L1 opposes sudden changes in current by storing energy in its magnetic field. The output capacitor Co supplies the load with current, smoothing out the output voltage Vo. When the high side switch QH is turned off, and the low side switch QL is turned on, the output inductor L1 releases its stored energy to maintain the current flow to the load. The output capacitor Co continues to smooth the output voltage. In operation, the duty cycle (the ratio of the turn-on time of the high side switch QH to the total switching period) is used to control the output voltage Vo. By adjusting the duty cycle, the output voltage Vo can be regulated at a predetermined level.

In accordance with an embodiment, the switches (e.g., switches QH and QL) may be metal oxide semiconductor field-effect transistor (MOSFET) devices. Alternatively, the switches can be any controllable switches such as insulated gate bipolar transistor (IGBT) devices, integrated gate commutated thyristor (IGCT) devices, gate turn-off thyristor (GTO) devices, silicon-controlled rectifier (SCR) devices, junction gate field-effect transistor (JFET) devices, MOS controlled thyristor (MCT) devices, gallium nitride (GaN)-based power devices, silicon carbide (SiC)-based power devices and the like.

It should be noted while FIG. 2 shows the switches QH and QL are implemented as single n-type transistors, a person skilled in the art would recognize there may be many variations, modifications and alternatives. For example, depending on different applications and design needs, the switches QH and QL may be implemented as p-type transistors. Furthermore, each switch shown in FIG. 2 may be implemented as a plurality of switches connected in parallel. Moreover, a capacitor may be connected in parallel with one switch to achieve zero voltage switching (ZVS)/zero current switching (ZCS).

FIG. 3 illustrates a block diagram of a frequency control apparatus in accordance with various embodiments of the present disclosure. The controller 200 shown in FIG. 1 comprises a frequency control apparatus configured to adjust a threshold voltage of an on-timer so that the switching frequency of the power conversion system matches a predetermined switching frequency. In some embodiments, the predetermined switching frequency is a reference frequency saved in a lookup table.

As shown in FIG. 3, the frequency control apparatus comprises a sampling circuit 311, a reference frequency unit 312, a comparison unit 313 and an on-time adjustment unit 314. As shown in FIG. 3, the sampling circuit 311 is configured to sample the PWM signal and create a digital representation (PWM_TP) of the PWM signal. In some embodiments, the digital representation of the PWM signal is the digital representation of the time period of the PWM signal. The reference frequency unit 312 is configured to provide a reference frequency signal (RF_TP). In some embodiments, the reference frequency signal is from a lookup table. The reference frequency signal is the time period of a predetermined reference frequency. In some embodiments, the reference frequency signal is of a frequency of 24 Megahertz. A sampling frequency of the sampling circuit 311 is 600 Megahertz.

As shown in FIG. 3, the comparison unit 313 is configured to compare the digital representation (PWM_TP) of the PWM signal with the reference frequency signal (RF_TP). In each switching cycle of the power conversion system, the comparison unit 313 compares the time period of the PWM signal with the time period of the reference switching frequency to calculate a frequency difference. Based on the comparison results in N switching cycles, the comparison unit 313 is configured to calculate an average of N frequency differences, and generate a frequency control signal FCTRL based on the calculated average. In some embodiments, N is in a range from about 1,000 to about 10,000.

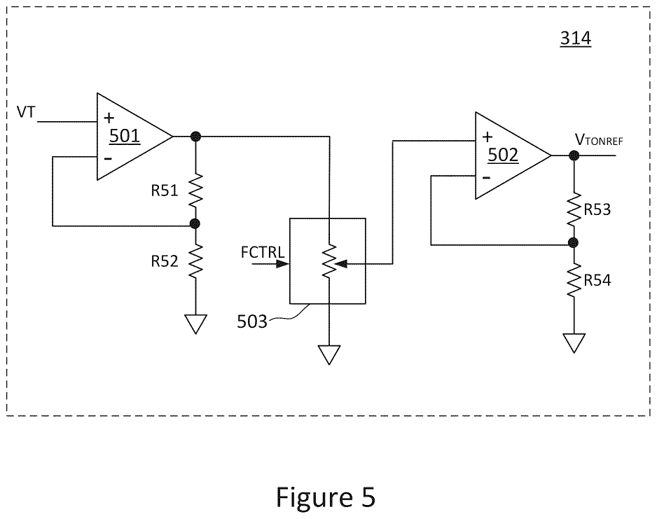

The frequency control signal FCTRL is fed into the on-time adjustment unit 314. Based on the received frequency control signal FCTRL, the on-time adjustment unit 314 is able to adjust the voltage threshold of the on-timer, thereby modifying the turn-on time of the high side switch. In particular, increasing the voltage threshold of the on-timer extends the high-side switch's on-time, which decreases the switching frequency. Conversely, decreasing the voltage threshold of the on-timer shortens the on-time, leading to an increased switching frequency. The detailed operation of the on-time adjustment unit 314 is further explained below in reference to FIG. 5.

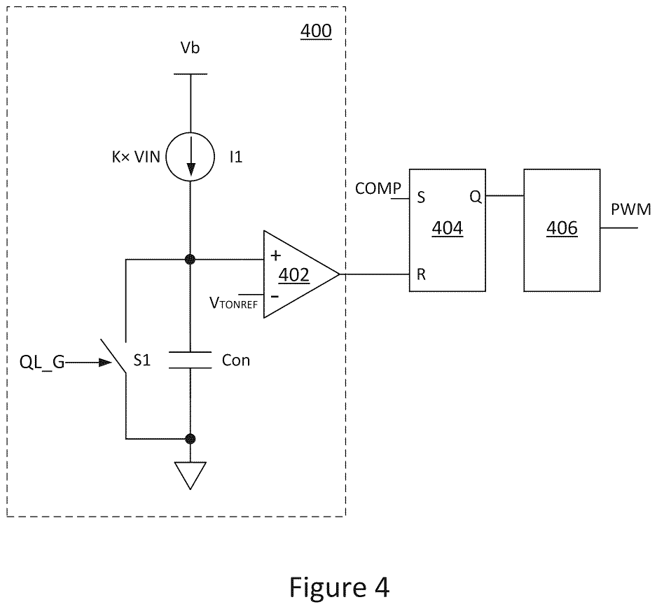

FIG. 4 illustrates a schematic diagram of a constant on-timer in accordance with various embodiments of the present disclosure. The constant on-timer 400 is part of the controller 200. The controller 200 further comprises a latch 402 and a logic control unit 406. As shown in FIG. 4, a set input of the latch 404 is configured to receive a comp signal. In some embodiments, the comp signal is tapped at an output of a comparator. An inverting input of the comparator is connected to the output of the power converter through a resistor divider. A non-inverting input of the comparator is configured to receive a predetermined reference. A compensation network is coupled between the output of the comparator and ground. In operation, the comparator compares the output voltage with a predetermined reference. When the output voltage falls below the predetermined reference, the comp signal has a logic high state. This logic high state determines a turn-on instant of the high side switch.

As shown in FIG. 4, a reset input of the latch 404 is configured to receive the reset signal. This reset signal is generated by the constant on-timer 400. An input of the logic control unit 406 is configured to receive an output of the latch 404. An output of the logic control unit 406 is configured to generate the PWM signal.

The constant on-timer 400 comprises a current source I1, a capacitor Con, a control switch S1 and a comparator 402. As shown in FIG. 4, the current source I1 and the capacitor Con are connected in series between a bias voltage Vb and ground. A current flowing through the current source I1 is proportional to the input voltage VIN. I1 is equal to K×VIN as shown in FIG. 4. The control switch S1 is connected in parallel with the capacitor Con. The control switch S1 is controlled by the low side gate drive signal QL_G. A non-inverting input of the comparator 402 is connected to a common node of the current source I1 and the capacitor Con.

An inverting input of the comparator 402 is configured to receive a threshold voltage V_{TONREF}. In some embodiments, the threshold voltage V_{TONREF} is adjustable. In particular, the on-time adjustment unit 314 shown in FIG. 3 is able to adjust the threshold voltage V_{TONREF} so as to modify the switching frequency of the power conversion system. An output of the comparator 402 is configured to generate the reset signal to turn off the high side switch.

In operation, when the high side switch QH is turned on, a logic level “1” and a logic level “0” are applied to the set input and the reset input of the latch 404, respectively. In response to the logic change at the input of the latch 404, the logic control unit 406 generates a logic level “1” at PWM. The PWM signal is fed into the driver 110 shown in FIG. 2. The driver 110 generates a logic level “1” at QH_G and a logic level “0” at QL_G. The logic level “0” at QL_G turns off the switch S1. As a result of turning off the switch S1, the current source I1 starts to charge the capacitor Con in a linear manner. The voltage across the capacitor Con is compared with the threshold voltage V_{TONREF} at the comparator 402. After the voltage across the capacitor Con reaches the voltage of the threshold voltage V_{TONREF}, the output of the comparator 402 generates a logic level “1” which resets the latch 404 and generates a logic level “0” at the Q output of the latch 404. The logic level “0” at the Q output is used to turn off the high side switch QH. Upon turning off the high side switch QH, the driver 110 generates a logic level “1” at QL_G, which turns on the low-side switch QL. As shown in FIG. 4, the logic level “1” at QL_G is also used to turn on the switch S1. The turned-on switch S1 discharges the capacitor Con and maintains the voltage across the capacitor Con equal to about zero. As such, the voltage across the capacitor Con is a voltage ramp. This voltage ramp is in sync with the gate drive signal applied to the high side switch QH. In other words, the voltage ramp starts from zero and linearly rises during the turn-on time of the high side switch QH. The voltage ramp goes back to zero at the trailing edge of the gate drive signal applied to the high side switch QH.

In operation, the duty cycle of the power converter can be expressed by the following equation:

$$D = \frac{{T}_{ON}}{T} = \frac{V o}{V IN} \qquad ( 1 )$$

In Equation (1), D is the duty cycle. T_{ON} is the on-time of the high side switch QH. T is a time period of the switching cycle of the power converter.

The switching frequency of the power converter can be expressed by the following equation:

$$f = \frac{1}{T} = \frac{V o}{V IN \times {T}_{O N}} \qquad ( 2 )$$

Equation (2) indicates that by increasing the on-time T_{ON} reduces the switching frequency, while decreasing the on-time T_{ON} increases it. The on-time is governed by the threshold voltage. To obtain a switching frequency matching the reference frequency, the threshold voltage V_{TONREF} is modulated based on the frequency difference, thereby adjusting T_{ON} and the resulting switching frequency. The detailed process will be described below with respect to FIG. 5.

FIG. 5 illustrates a schematic diagram of the on-time adjustment unit shown in FIG. 3 in accordance with various embodiments of the present disclosure. The on-time adjustment unit 314 comprises a first amplifier 501, a second amplifier 502, a digital potentiometer 503, a first resistor R51, a second resistor R52, a third resistor R53 and a fourth resistor R54.

As shown in FIG. 5, a non-inverting input of the first amplifier 501 is configured to receive a predetermined target reference voltage VT. The first resistor R1 and the second resistor R2 are connected in series between an output of the first amplifier 501 and ground. An inverting input of the first amplifier 501 is connected to a common node of the first resistor R51 and the second resistor R52. The digital potentiometer 503 is connected between the output of the first amplifier 501 and ground. An input of the digital potentiometer 503 is configured to receive the frequency control signal FCTRL generated by the comparison unit 313. A non-inverting input of the second amplifier 502 is connected to an output of the digital potentiometer 503. The third resistor R53 and the fourth resistor R54 are connected in series between an output of the second amplifier 502 and ground. An inverting input of the second amplifier 502 is connected to a common node of the third resistor R53 and the fourth resistor R54. An output of the second amplifier 502 is configured to generate the threshold voltage V_{TONREF}.

V_{TONREF} can be expressed by the following equation:

$${V}_{TONREF} = V T \times ( 1 + \frac{R 51}{R 52} ) \times K D \times ( 1 + \frac{R 53}{R 54} ) \qquad ( 3 )$$

In Equation (3), KD is the voltage division ratio of the digital potentiometer 503.

In operation, the frequency control signal FCTRL is a digital signal. The digital potentiometer 503 is a resistive element with multiple discrete steps and electronic switches controlled by the digital signal. By increasing or decreasing the value of the digital signal, the output of the digital potentiometer 503 is adjusted accordingly, thereby achieving the desired voltage division ratio. This voltage division ratio is used to adjust the threshold voltage V_{TONREF}, thereby adjusting T_{ON} and the resulting switching frequency.

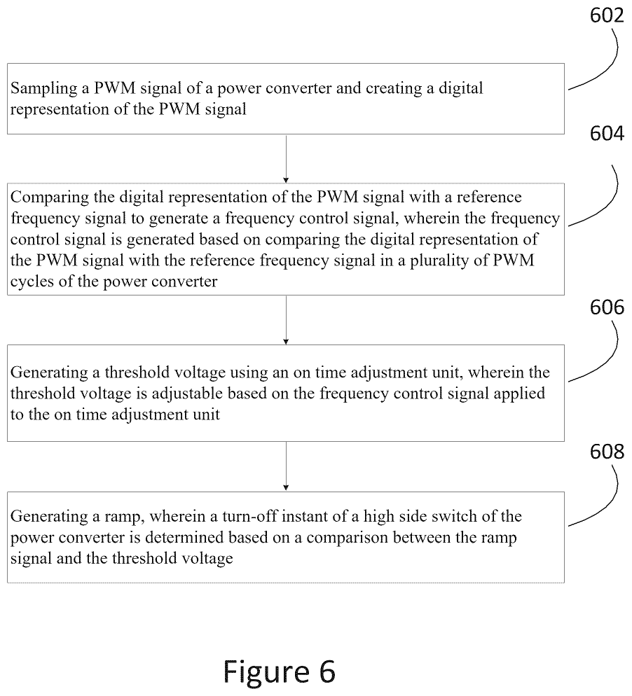

FIG. 6 illustrates a flow chart of a method for controlling the switching frequency in the power conversion system shown in FIG. 1 in accordance with various embodiments of the present disclosure. This flowchart shown in FIG. 6 is merely an example, which should not unduly limit the scope of the claims. One of ordinary skill in the art would recognize many variations, alternatives, and modifications. For example, various steps illustrated in FIG. 6 may be added, removed, replaced, rearranged and repeated.

At step 602, a PWM signal of a power converter is sampled, and a digital representation of the PWM signal is created.

At step 604, the digital representation of the PWM signal is compared with a reference frequency signal to generate a frequency control signal, wherein the frequency control signal is generated based on comparing the digital representation of the PWM signal with the reference frequency signal in a plurality of PWM cycles of the power converter.

At step 606, a threshold voltage is generated using an on-time adjustment unit, wherein the threshold voltage is adjustable based on the frequency control signal applied to the on-time adjustment unit.

At step 608, a ramp is generated, wherein a turn-off instant of a high side switch of the power converter is determined based on a comparison between the ramp signal and the threshold voltage.

The method further comprises generating the ramp using a current source having a current level proportional to an input voltage of the power converter.

In some embodiments, the on-time adjustment unit comprises a first amplifier, a second amplifier, a digital potentiometer, a first resistor, a second resistor, a third resistor and a fourth resistor, and wherein a non-inverting input of the first amplifier is configured to receive a predetermined target reference voltage, the first resistor and the second resistor are connected in series between an output of the first amplifier and ground, an inverting input of the first amplifier is connected to a common node of the first resistor and the second resistor, the digital potentiometer is connected between the output of the first amplifier and ground, and wherein an input of the digital potentiometer is configured to receive the frequency control signal, a non-inverting input of the second amplifier is connected to an output of the digital potentiometer, the third resistor and the fourth resistor are connected in series between an output of the second amplifier and ground, an inverting input of the second amplifier is connected to a common node of the third resistor and the fourth resistor, and an output of the second amplifier is configured to generate the threshold voltage.

In some embodiments, the power converter comprises the high side switch, a low side switch, an inductor and an output capacitor, and wherein the high side switch and the low side switch are connected in series between an input voltage bus and ground, the inductor is connected between a common node of the high side switch and the low side switch, and an output voltage bus, and the output capacitor is connected between the output voltage bus and ground.

The method further comprises in each switching cycle of the power converter, comparing the digital representation of the PWM signal with the reference frequency signal to obtain a frequency difference, and generating the frequency control signal based on an average of N frequency differences obtained in N switching cycles.

In some embodiments, N is in a range from about 1,000 to about 10,000.

Although the description has been described in detail, it should be understood that various changes, substitutions and alterations can be made without departing from the spirit and scope of this disclosure as defined by the appended claims. Moreover, the scope of the disclosure is not intended to be limited to the particular embodiments described herein, as one of ordinary skill in the art will readily appreciate from this disclosure that processes, machines, manufacture, compositions of matter, means, methods, or steps, presently existing or later to be developed, which may perform substantially the same function or achieve substantially the same result as the corresponding embodiments described herein, may be utilized according to the present disclosure. Accordingly, the appended claims are intended to include within their scope such processes, machines, manufacture, compositions of matter, means, methods, or steps.

What is claimed is:

1. An apparatus comprising:
a constant on-timer configured to determine a turn-off instant of a high side switch of a power converter based on a comparison between a ramp signal and a reference; and
a frequency correction unit comprising:
a sampling circuit configured to sample a pulse width modulation (PWM) signal and create a digital representation of the PWM signal;
a comparison unit configured to compare the digital representation of the PWM signal with a reference frequency signal to obtain a frequency difference in each PWM cycle of the power converter, wherein the comparison unit is configured to generate a frequency control signal based on an average of N frequency differences obtained in N PWM cycles; and
an on-time adjustment unit configured to adjust the refence based on the frequency control signal.

2. The apparatus of claim 1, wherein:
the reference frequency signal is of a frequency of 24 Megahertz; and
a sampling frequency of the sampling circuit is 600 Megahertz.

3. The apparatus of claim 1, wherein:
the on-time adjustment unit comprises a first amplifier, a second amplifier, a digital potentiometer, a first resistor, a second resistor, a third resistor and a fourth resistor, and wherein:
a non-inverting input of the first amplifier is configured to receive a predetermined target reference voltage;
the first resistor and the second resistor are connected in series between an output of the first amplifier and ground;
an inverting input of the first amplifier is connected to a common node of the first resistor and the second resistor;
the digital potentiometer is connected between the output of the first amplifier and ground, and wherein an input of the digital potentiometer is configured to receive the frequency control signal;
a non-inverting input of the second amplifier is connected to an output of the digital potentiometer;
the third resistor and the fourth resistor are connected in series between an output of the second amplifier and ground;
an inverting input of the second amplifier is connected to a common node of the third resistor and the fourth resistor; and
an output of the second amplifier is configured to generate the reference.

4. The apparatus of claim 1, wherein:
the constant on timer comprises a current source, a capacitor, a control switch and a comparator, and wherein:
the current source and the capacitor are connected in series between a bias voltage and ground;
the control switch is connected in parallel with the capacitor, wherein the control switch is controlled by a low side gate drive signal of the power converter;
an inverting input of the comparator is configured to receive the reference;
a non-inverting input of the comparator is connected to a common node of the current source and the capacitor; and
an output of the comparator is configured to generate a reset signal to turn off the high side switch of the power converter.

5. The apparatus of claim 4, further comprising:
a latch and a logic control unit, wherein:
a set input of the latch is configured to receive a comp signal determining a turn-on instant of the high side switch of the power converter;
a reset input of the latch is configured to receive the reset signal generated by the constant on timer;
an input of the logic control unit is configured to receive an output of the latch; and
an output of the logic control unit is configured to generate the PWM signal.

6. The apparatus of claim 1, wherein:
the power converter comprises the high side switch, a low side switch, an inductor and an output capacitor, and wherein:
the high side switch and the low side switch are connected in series between an input voltage bus and ground;
the inductor is connected between a common node of the high side switch and the low side switch, and an output voltage bus; and
the output capacitor is connected between the output voltage bus and ground.

7. The apparatus of claim 6, further comprising
a driver configured to receive the PWM signal and generate a high side gate drive signal for the high side switch and a low side gate drive signal for the low side switch.

8. The apparatus of claim 7, wherein:
the high side switch, the low side switch and the driver form a smart power stage.

9. The apparatus of claim 1, wherein:
N is in a range from about 1,000 to about 10,000.

10. The apparatus of claim 1, wherein:
the reference frequency signal is generated from a lookup table.

11. The apparatus of claim 1, wherein:
a switching frequency of the power converter is inversely proportional to an on-time of the high side switch of the power converter.

12. A method comprising:
sampling a PWM signal of a power converter and creating a digital representation of the PWM signal;
comparing the digital representation of the PWM signal with a reference frequency signal to generate a frequency control signal, wherein the frequency control signal is generated based on comparing the digital representation of the PWM signal with the reference frequency signal in a plurality of PWM cycles of the power converter;
generating a threshold voltage using an on-time adjustment unit, wherein the threshold voltage is adjustable based on the frequency control signal applied to the on-time adjustment unit; and
generating a ramp, wherein a turn-off instant of a high side switch of the power converter is determined based on a comparison between the ramp signal and the threshold voltage.

13. The method of claim 12, further comprising:
generating the ramp using a current source having a current level proportional to an input voltage of the power converter.

14. The method of claim 12, wherein:
the on-time adjustment unit comprises a first amplifier, a second amplifier, a digital potentiometer, a first resistor, a second resistor, a third resistor and a fourth resistor, and wherein:
a non-inverting input of the first amplifier is configured to receive a predetermined target reference voltage;
the first resistor and the second resistor are connected in series between an output of the first amplifier and ground;
an inverting input of the first amplifier is connected to a common node of the first resistor and the second resistor;
the digital potentiometer is connected between the output of the first amplifier and ground, and wherein an input of the digital potentiometer is configured to receive the frequency control signal;
a non-inverting input of the second amplifier is connected to an output of the digital potentiometer;
the third resistor and the fourth resistor are connected in series between an output of the second amplifier and ground;
an inverting input of the second amplifier is connected to a common node of the third resistor and the fourth resistor; and
an output of the second amplifier is configured to generate the threshold voltage.

15. The method of claim 12, wherein:
the power converter comprises the high side switch, a low side switch, an inductor and an output capacitor, and wherein:
the high side switch and the low side switch are connected in series between an input voltage bus and ground;
the inductor is connected between a common node of the high side switch and the low side switch, and an output voltage bus; and
the output capacitor is connected between the output voltage bus and ground.

16. The method of claim 12, further comprising:
in each switching cycle of the power converter, comparing the digital representation of the PWM signal with the reference frequency signal to obtain a frequency difference; and
generating the frequency control signal based on an average of N frequency differences obtained in N switching cycles.

17. The method of claim 16, wherein:
N is in a range from about 1,000 to about 10,000.

18. A power conversion system comprising:
a power converter connected between an input voltage bus and an output voltage bus; and
a controller comprising:
a constant on-timer configured to determine a turn-off instant of a high side switch of a power converter based on a comparison between a ramp signal and a reference; and
a frequency correction unit comprising:
a sampling circuit configured to sample a pulse width modulation (PWM) signal and create a digital representation of the PWM signal;
a comparison unit configured to compare the digital representation of the PWM signal with a reference frequency signal to obtain a frequency difference in each PWM cycle of the power converter, wherein the comparison unit is configured to generate a frequency control signal based on an average of N frequency differences obtained in N PWM cycles; and
an on-time adjustment unit configured to adjust the refence based on the frequency control signal.

19. The power conversion system of claim 18, wherein:
the on-time adjustment unit comprises a first amplifier, a second amplifier, a digital potentiometer, a first resistor, a second resistor, a third resistor and a fourth resistor, and wherein:
a non-inverting input of the first amplifier is configured to receive a predetermined target reference voltage;
the first resistor and the second resistor are connected in series between an output of the first amplifier and ground;
an inverting input of the first amplifier is connected to a common node of the first resistor and the second resistor;
the digital potentiometer is connected between the output of the first amplifier and ground, and wherein an input of the digital potentiometer is configured to receive the frequency control signal;
a non-inverting input of the second amplifier is connected to an output of the digital potentiometer;
the third resistor and the fourth resistor are connected in series between an output of the second amplifier and ground;
an inverting input of the second amplifier is connected to a common node of the third resistor and the fourth resistor; and
an output of the second amplifier is configured to generate the reference.

20. The power conversion system of claim 19, further comprising a latch and a logic control unit, wherein:
the constant on timer comprises a current source, a capacitor, a control switch and a comparator, and wherein:
the current source and the capacitor are connected in series between a bias voltage and ground;
the control switch is connected in parallel with the capacitor, wherein the control switch is controlled by a low side gate drive signal;
an inverting input of the comparator is configured to receive the reference;
a non-inverting input of the comparator is connected to a common node of the current source and the capacitor; and
an output of the comparator is configured to generate a reset signal to turn off the high side switch;
a set input of the latch is configured to receive a comp signal determining a turn-on instant of the high side switch;
a reset input of the latch is configured to receive the reset signal;
an input of the logic control unit is configured to receive an output of the latch; and
an output of the logic control unit is configured to generate the PWM signal.
